(19) United States
(12) Patent Application Publication
(10) Pub. No.: US 2015/0036247 A1
(43) Pub. Date: Feb. 5, 2015

(54) APPARATUS FOR A VOLTAGE PROTECTION TRANCEIVER AND DEVICE THEREWITH

(71) Applicant: Industrial Technology Research Institute, Hsinchu (TW)

(72) Inventor: Chin Hsia, Taichung City (TW)

(73) Assignee: Industrial Technology Research Institute, Hsinchu (TW)

(21) Appl. No.: 14/250,374

(22) Filed: Apr. 10, 2014

(30) Foreign Application Priority Data
Aug. 5, 2013 (TW) 102127971

(51) Int. Cl. H02H 9/04

(52) U.S. Cl. CPC H02H 9/04
USPC 361/56

(57) ABSTRACT

A voltage protection transceiver is introduced herein. The voltage protection transceiver includes a transmission element and a voltage-driven switch circuit. The voltage-driven switch circuit at least includes a sensing circuit and a protection switch. The voltage-driven switch circuit and the transmission element for transmitting input signals are separated from each other for maintaining integrity of transmission of signals. When a voltage level of the input signal is higher than a predetermined value and being detected by the sensing circuit, the voltage-driven switch circuit is turned on to protect electrical components at an output stage from being damaged or influenced by the high-level input signals. When the voltage level of input signals is lower than the predetermined value, the voltage-driven switch circuit is turned off to reach an output without power loss.

### CROSS-REFERENCE TO RELATED APPLICATION

This application claims the priority benefit of Taiwan application serial no. 102127971, filed on Aug. 5, 2013. The entirety of the above-mentioned patent application is hereby incorporated by reference herein and made a part of this specification.

### BACKGROUND

1. Technical Field

The disclosure relates to a voltage protection transceiver.

2. Related Art

Ultrasound equipment in pulse-echo applications requires a high-voltage protection element to protect low-voltage devices in the receive chain from being influenced by a high-voltage pulse wave transmission. A diode bridge is generally used as a protection device because of its simplicity of the design and wideband performance, though the bias circuitry of the diode bridge is power consuming and the diodes inherently have excessive interference noises. Alternatively, field effect transistors are used to replace the diode devices in the bridge due to their high power capability and low insertion loss, though a bias and control circuitry is still required. When the number of channels of ultrasonic scanners increases, the overall power consumption of the aforementioned designs becomes not appropriate for the application in a handheld electronic device which requires low power dissipation.

### SUMMARY

An exemplary embodiment of the disclosure provides a voltage protection transceiver including a transmission element and a voltage-driven switch circuit. The transmission element includes a first terminal coupled to an input terminal for receiving an input signal, and a second terminal coupled to an output terminal. The voltage-driven switch circuit, connected to the transmission element, detects a voltage value at the first terminal of the transmission element. When the voltage value at the first terminal is lower than a predetermined voltage value, the voltage-driven switch circuit is in a turn-off state, and when the voltage value at the first terminal is higher than the predetermined voltage value, the voltage-driven switch circuit is in a turn-on state and forms a first current path connected to ground, so as to electrically couple the output terminal, which is coupled to the second terminal of the transmission element, to the ground.

An exemplary embodiment of the disclosure provides a voltage protection transceiver including first and second transmission elements and a first and second voltage-driven switch circuits. The first transmission element includes a first terminal coupled to an input terminal for receiving an input signal and a second terminal coupled to an output terminal. The first voltage-driven switch circuit, connected to the first transmission element, detects a voltage value at the first terminal of the first transmission element. When the voltage value at the first terminal is lower than a predetermined voltage value, the first voltage-driven switch circuit is in a turn-off state, and when the voltage value at the first terminal is higher than the predetermined voltage value, the first voltage-driven switch circuit is in a turn-on state and forms a first current path connected to ground, so as to electrically couple the output terminal, which is coupled to the second terminal of the first transmission element, to the ground. The second transmission element includes a third terminal coupled to the input terminal for receiving the input signal and a fourth terminal coupled to the output terminal. The second voltage-driven switch circuit, connected to the second transmission element, detects a voltage value at the third terminal of the second transmission element. When the voltage value at the third terminal is lower than the predetermined voltage value, the second voltage-driven switch circuit is in the turn-off state, and when the voltage value at the third terminal is higher than the predetermined voltage value, the second voltage-driven switch circuit is in the turn-on state and forms a second current path connected to the ground, so as to electrically couple the output terminal, which is coupled to the fourth terminal of the transmission element, to the ground.

An exemplary embodiment of the disclosure provides a voltage protection device including a plurality of voltage protection transceivers, where the voltage protection transceivers are connected in parallel and are coupled to an input signal for detecting a voltage value of the input signal. When the voltage value is lower than a predetermined voltage value, the voltage protection transceivers are in a turn-off state, and when the voltage value is higher than the predetermined voltage value, at least one of the voltage protection transceivers or at least a part of the voltage protection transceivers are in a turn-on state and form one or a plurality of current paths for coupling an output terminal of the voltage protection device to the ground.

An exemplary embodiment of the disclosure provides a voltage protection device including a plurality of voltage protection transceivers, where the voltage protection transceivers are connected in series, where a first voltage protection transceiver of the voltage protection transceivers connected in series is coupled to an input signal for detecting a voltage value of the input signal. When the voltage value is lower than a predetermined voltage value, the voltage protection transceivers are in a turn-off state, and when the voltage value is higher than the predetermined voltage value, the voltage protection transceivers are in a turn-on state and form one or a plurality of current paths for coupling an output terminal of the voltage protection device to the ground.

An exemplary embodiment of the disclosure provides a voltage protection device including a plurality of voltage protection transceivers, where the voltage protection transceivers are arranged in an array, where the voltage protection transceivers in the same row are coupled to an input signal in parallel, and the voltage protection transceivers in the same column are electrically coupled in series, where a first voltage protection transceiver of the voltage protection transceivers connected in series is coupled to the input signal, and the voltage protection transceivers are used for detecting a voltage value of the input signal. When the voltage value is lower than a predetermined voltage value, the voltage protection transceivers are in a turn-off state, and when the voltage value is higher than the predetermined voltage value, at least one voltage protection transceiver or at least a part of voltage protection transceivers are in a turn-on state and form one or a plurality of current paths for coupling an output terminal of the voltage protection device to the ground.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a voltage protection transceiver according to an exemplary embodiment of the disclosure.

FIG. 2A is a schematic diagram of a voltage protection transceiver according to an exemplary embodiment of the disclosure.

FIG. 2B is a schematic diagram of a voltage protection transceiver according to an embodiment of the disclosure.

FIG. 3 is a schematic diagram of a voltage protection transceiver according to an embodiment of the disclosure.

FIG. 4 is a schematic diagram of a voltage protection transceiver according to an embodiment of the disclosure.

FIG. 5 is a schematic diagram of a voltage protection transceiver according to an embodiment of the disclosure.

FIG. 6 is a schematic diagram of a voltage protection transceiver according to an embodiment of the disclosure.

FIG. 7A-7C are schematic diagrams of N-type and P-type voltage protection transceivers according to different embodiments of the disclosure.

FIG. 8A is a schematic diagram of a voltage protection transceiver according to an embodiment of the disclosure.

FIGS. 8B-8C are schematic diagrams of a voltage protection transceiver arranged in a serial or parallel method according to an embodiment of the disclosure.

FIG. 9 is a schematic diagram of a voltage protection transceiver arranged in an array according to an embodiment of the disclosure.

### DETAILED DESCRIPTION OF DISCLOSED EMBODIMENTS

The disclosure provides a high voltage protection transceiver with low power consumption and without power supply, which can be applied in technical fields such as ultrasound, wireless communication, mechanical engineering, biomedicine, etc. Compared to a conventional high voltage protection transceiver, the disclosure provides a design which can be automatic triggered and require no power supply. The design at least has an advantage in a plurality of exemplary embodiments, for example, it is adapted to various broadband low voltage transmissions without being influenced by input signals with a high voltage level.

The high voltage protection transceiver with low power consumption and without power supply provided by the disclosure may be integrated to a front-end circuit or a backend circuit, which provides less external noise and has no limitation, and can be applied to various high voltage processes. The provided device can be easy for integration in the array arrangement of an integrated circuit. Compared to the conventional circuit design, the provided device can be used to safely and quickly protect a low voltage circuit, so as to avoid damage caused by a high voltage signal and reduce insertion loss in signal transmission and decrease overall system noise.

In some exemplary embodiments of the voltage protection transceiver provided by the disclosure, the voltage protection transceiver may include a high voltage protection switch and a low voltage transmission element. The high voltage protection switch includes a sensing circuit and a protection switch. The low voltage transmission element may include a transistor or a resistor with adjustable impedance. In case of an input signal with a high voltage level, the switch is automatically turned on to protect components at an output stage, and in case of an input signal with a low voltage level, the switch is automatically turned off to reach an approximate non-loss output.

One or a part of embodiments of the disclosure provides a voltage protection transceiver including a transmission element and a voltage-driven switch circuit. The voltage-driven switch circuit at least includes a sensing circuit and a protection switch. The high voltage-driven switch circuit and the low voltage transmission element are separated from each other for maintaining integrity of transmission of signals. In case of the input signal with a high voltage level, the voltage-driven switch circuit is automatically turned on to protect electrical components at the output stage from being damaged or influenced by the high voltage level input signals. In case of the input signal with a low voltage level, the voltage-driven switch circuit is automatically turned off to reach an approximate non-loss output.

One or a part of embodiments of the disclosure provides a voltage protection transceiver including a transmission element and a voltage-driven switch circuit. The voltage-driven switch circuit at least includes a sensing circuit and a protection switch. The high voltage-driven switch circuit and the low voltage transmission element are separated from each other for maintaining integrity of transmission of the signals. In case of an input signal with a high voltage level, the voltage-driven switch circuit is automatically turned on to protect components at the output stage from being damaged or influenced by the high voltage level input signals. In case of an input signal with a high voltage level, the voltage-driven switch circuit is automatically turned off to reach an approximate non-loss output. Different embodiments are provided below with reference of figures for description.

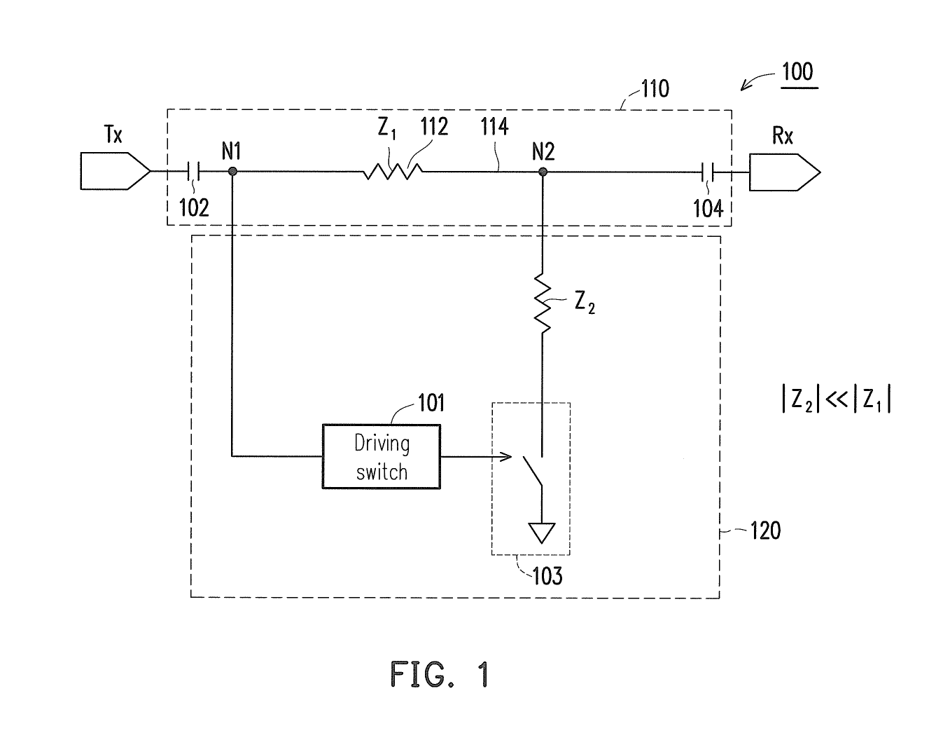

FIG. 1 is a structural schematic diagram of a voltage protection transceiver according to an exemplary embodiment of the disclosure. The voltage protection transceiver 100 includes a transmission element 110 and a voltage-driven switching circuit 120. The voltage-driven switch circuit 120 at least includes a sensing circuit and a protection switch. The voltage protection transceiver 100 arranged in parallel with the voltage-driven switching circuit 120 can be used to limit the voltage value at an output node of the transmission element 110 while an input node of the transmission element 110 is feeding with a high voltage signal (spike or harmonic signals). The voltage-driven switch circuit 120 can be activated by the high voltage signals coupled at the input terminal of the transmission element 110.

The voltage-driven switch circuit 120 is connected to the transmission element 110, and is configured to detect a voltage value at an input terminal of the transmission element 110, where when the voltage value is lower than a predetermined voltage value, the voltage-driven switch circuit 120 is in a turn-off state, and when the voltage value is higher than the predetermined voltage value, the voltage-driven switch circuit 120 is in a turn-on state and forms a current path connected to ground, so as to electrically coupled an output terminal of the transmission element 110 to the ground.

In an embodiment, the voltage-driven switch circuit 120 at least includes a protection switch 101 and a switch circuit 103, where the protection switch 101 is used for detecting a voltage value at the input terminal (N1) of the transmission element 110, and accordingly controls a conducting state of the switch circuit 103. One terminal of the switch circuit 103 is coupled to the output terminal (N2) of the transmission element 110, and another terminal thereof is coupled to the ground. When the switch circuit 103 is turned on, a current path is formed to electrically couple the output terminal of the transmission element 110 to the ground.

In an embodiment, the transmission element 110 includes an impedance element Z1, and the switch circuit 103 includes a resistor Z2. When the current path is formed, the impedance element Z1 and the resistor Z2 form a voltage dividing circuit, where a resistance of the impedance element Z1 is greater than that of the resistor Z2 of the switch circuit 101. In an embodiment, the resistance of the impedance element Z1 is far greater than that of the resistor Z2, so as to effectively decrease the voltage value on the transmission element 110.

The impedance element Z1 can be a resistor, an adjustable resistor, a metal oxide semiconductor field effect transistor (MOSFET) or any other device having or including a resistance characteristic. The resistor Z2 can also be a resistor, an adjustable resistor, a MOSFET or any other device having or including a resistance characteristic. In another embodiment, if the switch circuit 103 is a MOSFET, the resistance of the resistor Z2 can be a resistance of the MOSFET itself.

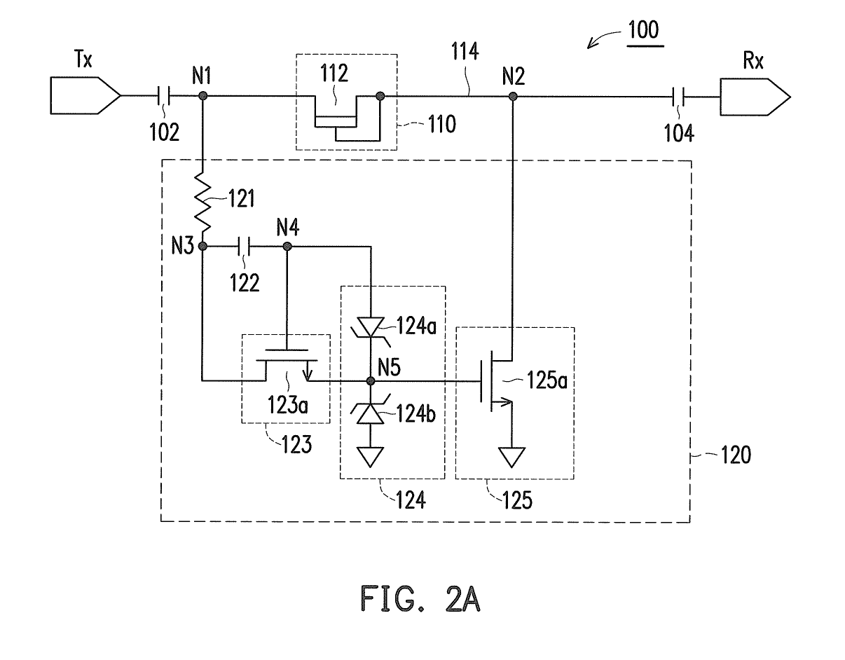

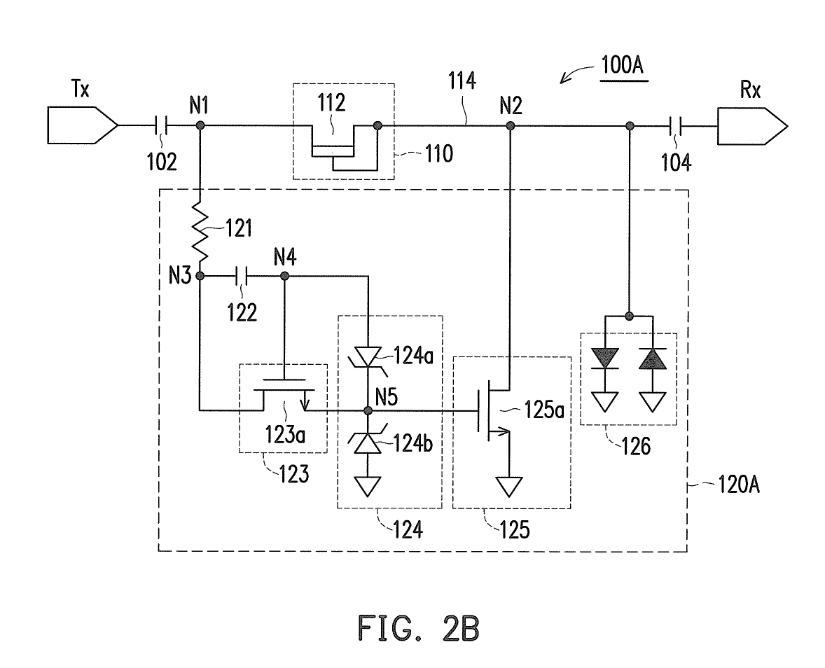

FIG. 2A is a schematic diagram of a voltage protection transceiver according to an exemplary embodiment of the disclosure. The voltage protection transceiver 100 includes a transmission element 110 and a voltage-driven switch circuit 120.

In the embodiment, the transmission element 110 includes an impedance element 112 and a transmission circuit 114. The transmission element 110 is connected to a transmission terminal (Tx) and is connected to a receiving terminal (Rx). In an embodiment, a capacitor 102 can be disposed between the transmission element 110 and the transmission terminal (Tx) to serve as a coupling device. A capacitor 104 can also be disposed between the transmission element 110 and the receiving terminal (Rx) to serve as a coupling device. In an embodiment, the impedance element 112 can be a resistor, a MOSFET or any other any device having a resistance characteristic.

In an embodiment, one terminal of the voltage-driven switch circuit 120 is connected to a connection node N1 of the transmission element 110, another terminal thereof is connected to a connection node N2 of the transmission element 110, and the impedance element 112 is located between the two connection nodes N1 and N2. When the voltage value of the input signal is in a lower state, i.e. when the voltage value of the connection node N1 is relatively low, the voltage-driven switch circuit 120 is in a turn-off state, and the voltage-driven switch circuit 120 is isolated from the input signal. In the embodiment, the situation that the voltage value of the input signal is in the lower state refers to that the signal to be transmitted by the transmission element is within a voltage range of a general or normal state, for example, the signal voltage range of the normal state is between peak voltages of several hundred mili-volts (mV) to 2 volts (V).

When the voltage value of the input signal is gradually increased to reach a constant value, i.e. the voltage value of the connection node N1 is relatively high, the voltage-driven switch circuit 120 is in a turn-on state, and now the protection switch 125 establishes a current path connected to the ground at the connection node N2 for coupling the connection node N2 to the ground, so that the receiving terminal (Rx) coupled to the voltage protection transceiver 100 is avoided to be impacted by a high voltage signal input through the voltage protection transceiver 100.

In one of a plurality of embodiments, when the voltage-driven switch circuit 120 is in the turn-on state, a resistance is further provided in the current path established by the protection switch 125 to form a voltage dividing circuit with the impedance element 112 of the transmission element 110, so that when the voltage value of the input signal exceeds a predetermined value, impact of the high voltage level input signal on the electronic components of the output terminal is effectively mitigated.

In one of a plurality of embodiments, the voltage-driven switch circuit 120 includes a decoupling element 123, a protection circuit 124 and a protection switch 125. The voltage-driven switch circuit 120 further includes a plurality of passive components for connecting the aforementioned protection circuit 124 to the transmission element 110. For example, in an embodiment, the decoupling element 123 can be a decoupling transistor. The protection circuit 124 can be a back-to-back gate protection diode. The protection switch 125 can be an N-channel MOSFET or a P-channel MOSFET. In another embodiment, the voltage protection transceiver 100A may include a limiter 126 (which is described in detail later) as that shown in FIG. 2B. The limiter 126 further limits a voltage value of the voltage protection transceiver 100A at the output terminal by using a breakdown voltage of semiconductor device. The limiter 126 may adopt a structure of a diode wheel.

The input terminal of the voltage-driven switch circuit 120 is coupled to the transmission element 110 via the decoupling element 123 through the passive components. As that shown in FIG. 2B, the passive components, for example, include a resistor 121 and a capacitor 122. One end of the resistor 121 is coupled to the connection node N1 of the transmission element 110. Another end of the resistor 121 is coupled to a connection node N3, and is coupled to an input terminal of the decoupling element 123, and is coupled to a control terminal of the decoupling element 123 and the protection circuit 124 through the capacitor 122 and a connection node N4. An output terminal of the decoupling element 123 is connected to the protection switch 125 for controlling an operation state of the protection switch 125. In an embodiment, the decoupling element 123 may adopts a MOSFET 123a, where a gate thereof is connected to the connection node N4, and drain/source terminals thereof are respectively connected to the connection node N3 and a connection node N5.

The protection circuit 124 is disposed between the decoupling element 124 and the protection switch 125, and may adopt a structure of a back-to-back gate protection diode. As that shown in FIG. 2B, in one embodiment, the protection circuit 124 includes two Zener diodes 124a and 124b. An anode of the Zener diode 124a is connected to the connection node N4, and a cathode thereof is connected to the connection node N5 coupled between the decoupling element 123 and the protection switch 125. An anode of the Zener diode 124b is connected to the ground, and a cathode thereof is connected to the connection node N5 coupled between the decoupling element 123 and the protection switch 125. One terminal of the protection switch 125 is coupled to the connection node N2 of the transmission element 110, and another terminal thereof is coupled to the ground.

In an embodiment, the protection switch 125 may adopt a MOSFET 125a, where a gate thereof is connected to the connection node N5, and drain/source terminals thereof are respectively connected to the connection node N2 and the ground. According to the description of FIG. 1, the MOSFET 125a has a resistance itself, and when the current path is formed, the resistance of the protection switch 125 and the impedance element 112 of the transmission element 110 may construct the voltage dividing circuit.

When the voltage-driven switch circuit 120 is in the turn-off state, i.e. the voltage value of the input signal is relatively small, the decoupling element 123 is in the turn-off state, and the voltage-driven switch circuit 120 is isolated from the transmission element 110, i.e. isolated from the input signal. When the voltage value of the input signal is gradually increased to reach a constant value, the decoupling element 123 is switched to the turn-on state, and finally clamps the protection circuit 124 to a certain voltage, for example, if the back-to-back gate protection diode is used, the protection circuit 124 is maintained to a voltage value of the breakdown voltage. Now, the protection switch 125 is turned on to couple the voltage of the transmission element 110 to the ground, so as to short the output terminal of the voltage protection transceiver 100A to the ground and protect the output terminal of the voltage protection transceiver 100A from being impacted by the high voltage level signal input from the input terminal of the voltage protection transceiver 100A.

Referring to FIG. 2B, FIG. 2B is a schematic diagram of a voltage protection transceiver according to an embodiment of the disclosure. In the embodiment, the voltage protection transceiver 100A includes the transmission element 110 and a voltage-driven switch circuit 120A. Structures of the transmission element 110 and the voltage-driven switch circuit 120A may refer to that of FIG. 2A, and the same elements or structures adopt the same referential numbers, which are not repeated. A difference between the embodiments of FIG. 2B and FIG. 2A is that in the voltage-driven switch circuit 120A, a protection circuit 126 is added between the receiving terminal (Rx) and the connection node N2, and is coupled to the voltage value on the transmission element 110 to clamp the connection node to a certain voltage. In one or a part of a plurality of exemplary embodiments, the protection circuit 126 includes a diode wheel.

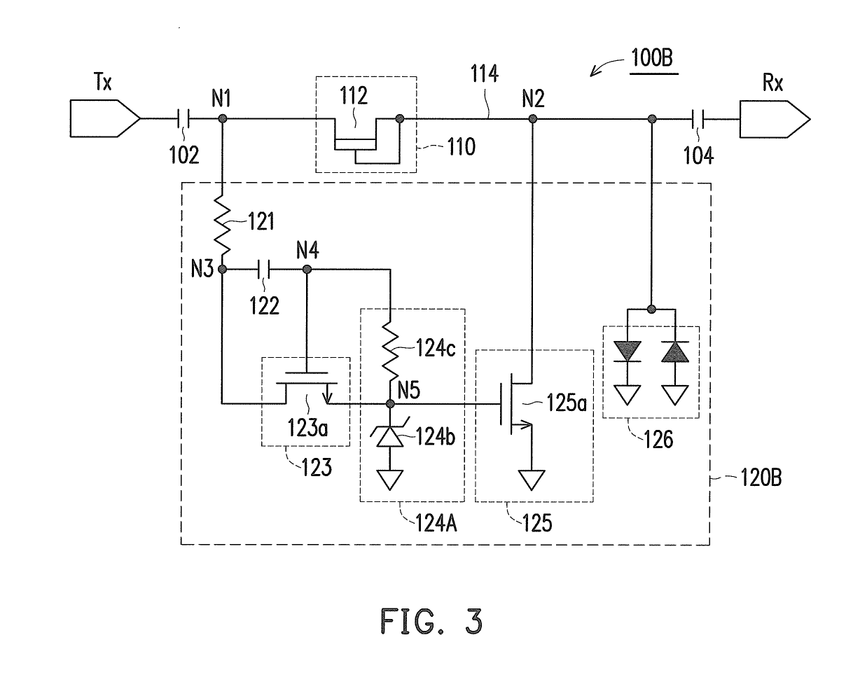

Referring to FIG. 3, FIG. 3 is a schematic diagram of a voltage protection transceiver according to an embodiment of the disclosure. In the embodiment, the voltage protection transceiver 100B includes the transmission element 110 and a voltage-driven switch circuit 120B. Structures of the transmission element 110 and the voltage-driven switch circuit 120B may refer to that of FIG. 2A, and the same elements or structures adopt the same referential numbers, which are not repeated. A difference between the embodiments of FIG. 3 and FIG. 2A is that in the voltage-driven switch circuit 120B, besides that the protection circuit 126 is added between the receiving terminal (Rx) and the connection node N2, the protection circuit 124A includes a resistor 124c and a Zener diode 124b.

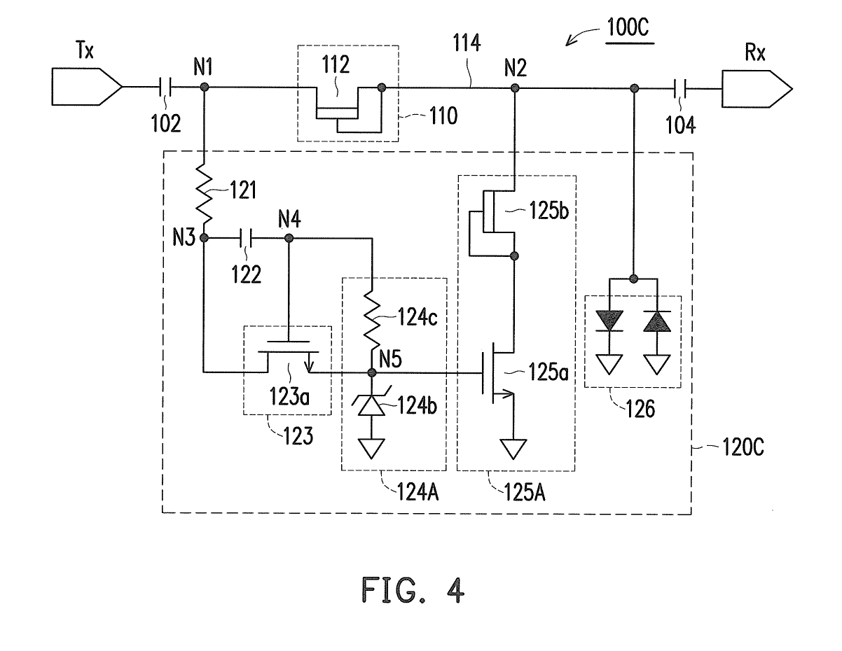

Referring to FIG. 4, FIG. 4 is a structural schematic diagram of a voltage protection transceiver according to an embodiment of the disclosure. In the embodiment, the voltage protection transceiver 100C includes the transmission element 110 and a voltage-driven switch circuit 120C. Structures of the transmission element 110 and the voltage-driven switch circuit 120C may refer to that of FIG. 2A, and the same elements or structures adopt the same referential numbers, which are not repeated. A difference between the embodiments of FIG. 4 and FIG. 2A is that in the voltage-driven switch circuit 120C, besides that the protection circuit 126 is added between the receiving terminal (Rx) and the connection node N2, and the protection circuit 124A includes the resistor 124c and the Zener diode 124b, a field effective transistor 125b is added to the protection switch 125A, where a gate of the field effective transistor 125b is connected to a drain/source terminal thereof to serve as an impedance element. According to the description of FIG. 1, when the current path is formed, the impedance of the field effective transistor 125b and the impedance element 112 of the transmission element 110 may construct a voltage dividing circuit.

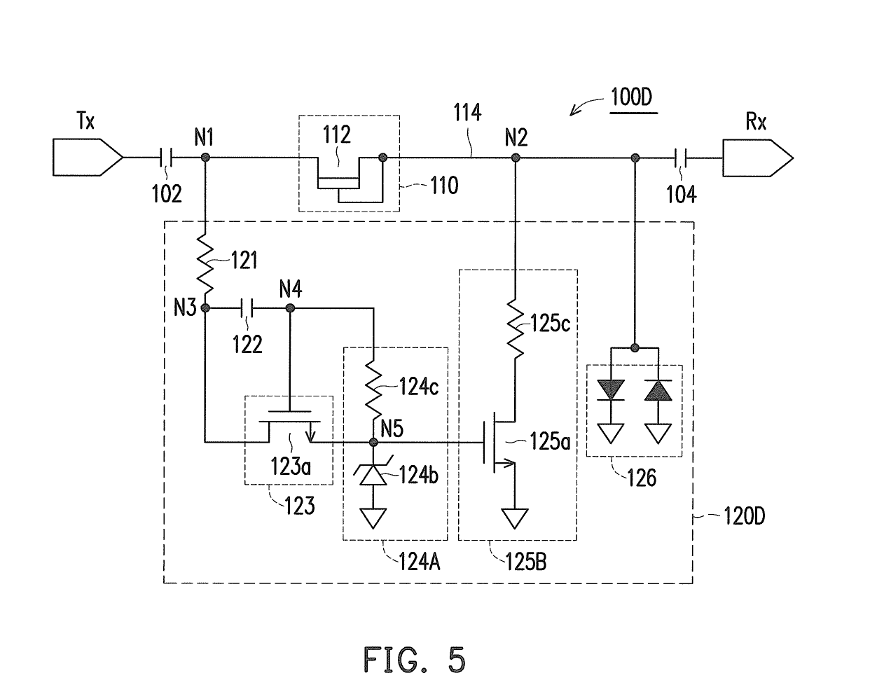

Referring to FIG. 5, FIG. 5 is a structural schematic diagram of a voltage protection transceiver according to an embodiment of the disclosure. In the embodiment, the voltage protection transceiver 100D includes the transmission element 110 and a voltage-driven switch circuit 120D. Structures of the transmission element 110 and the voltage-driven switch circuit 120D may refer to that of FIG. 2A, and the same elements or structures adopt the same referential numbers, which are not repeated. A difference between the embodiments of FIG. 5 and FIG. 2A is that in the voltage-driven switch circuit 120D, besides that the protection circuit 126 is added between the receiving terminal (Rx) and the connection node N2, and the protection circuit 124A includes the resistor 124c and the Zener diode 124b, the protection switch 125B adopts a resistor 125c, where the resistor 125c can be a passive component or an adjustable resistive element. According to the description of FIG. 1, when the current path is formed, the resistance of the resistor 125c and the impedance element 112 of the transmission element 110 may construct a voltage dividing circuit.

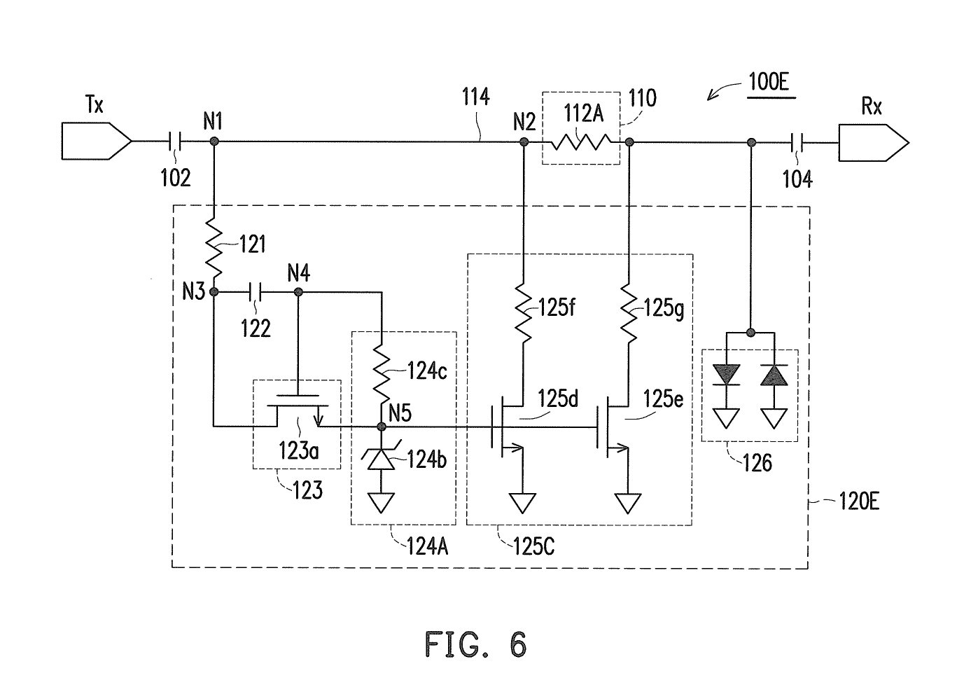

Referring to FIG. 6, FIG. 6 is a structural schematic diagram of a voltage protection transceiver according to an embodiment of the disclosure. In the embodiment, the voltage protection transceiver 100E includes the transmission element 110 and a voltage-driven switch circuit 120E. Structures of the transmission element 110 and the voltage-driven switch circuit 120E may refer to that of FIG. 2A, and the same elements or structures adopt the same referential numbers, which are not repeated. A difference between the embodiments of FIG. 6 and FIG. 2A is that in the voltage-driven switch circuit 120E, besides that the protection circuit 126 is added between the receiving terminal (Rx) and the connection node N2, and the protection circuit 124A includes the resistor 124c and the Zener diode 124b, the protection switch 125C adopts a combination of a plurality of field effective transistors connected in parallel and resistors. Regarding a structure capable of constructing a current path, the structure may include a field effective transistor and a resistor, and the resistor can be a passive component or an adjustable resistive element. As that shown in FIG. 6, a combination of the current path includes a field effective transistor 125d and a resistor 125f, and another combination of the current path includes a field effective transistor 125e and a resistor 125g. The impedance element 112A of the transmission element 110 may adopt a resistive element, which is connected between connection nodes on the transmission element 110 coupled to the two combinations of field effective transistors and resistors.

According to the descriptions of FIG. 1, when the current path is formed, resistances of the resistor 125f and/or the resistor 125g and the impedance element 112 of the transmission element 110 may construct a voltage dividing circuit. In the embodiment, the voltage protection transceiver of the disclosure may adopt the design of establishing multiple current paths, and as that described in the aforementioned exemplary embodiments, the resistor 125f and the resistor 125g can be omitted, and the resistance of the field effective transistors 125d and 125e is also applicable in such structure.

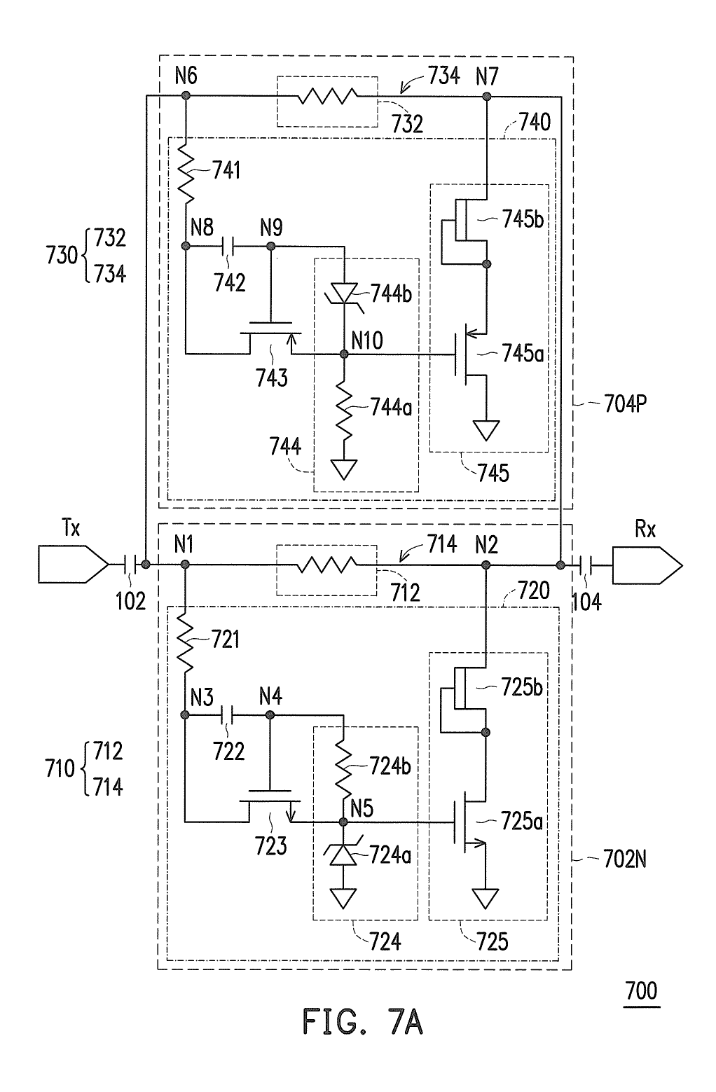

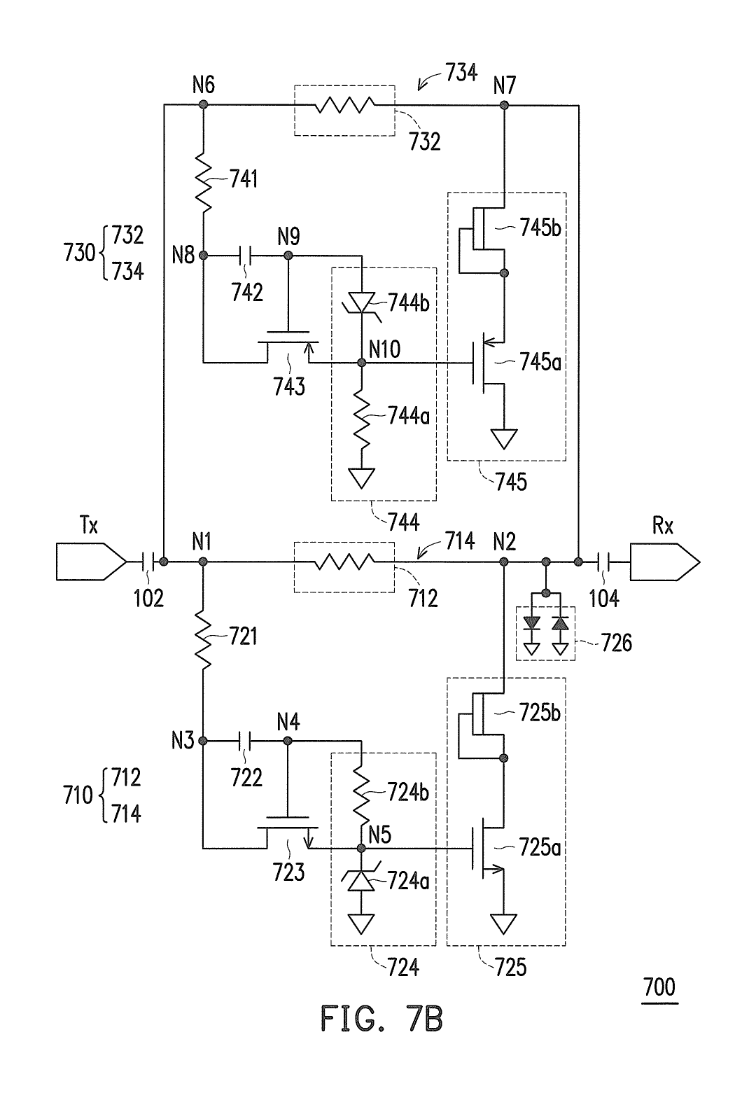

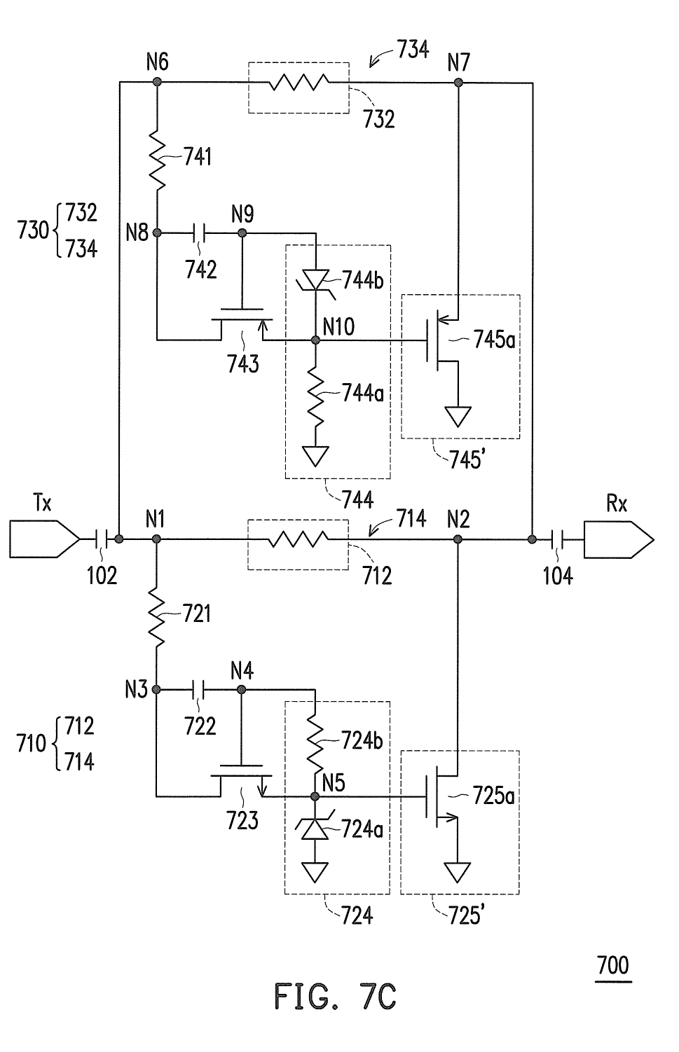

In the voltage protection transceiver provided by one or a part of exemplary embodiments of the disclosure, in case of a high voltage level signal input, the voltage-driven switch circuit is automatically turned on to protect electrical components of an output stage from being damaged or influenced by the high voltage level signal, and in case of a low voltage level signal input, the voltage-driven switch circuit is automatically turned off to reach an approximate non-loss output. In order to effectively maintain stableness of the transmission element, a parallel structure can be adopted to quickly protect the transmission path from being damaged by the high voltage level signal. Embodiments of FIGS. 7A-7C are provided below to describe the parallel structure.

FIG. 7A is a structural schematic diagram of a voltage protection transceiver according to an embodiment of the disclosure. The voltage protection transceiver 700 includes an upper part and a lower part, where the lower part is referred to as an N-type voltage protection transmission unit, and is indicated by 702N, and the lower part is referred to as a P-type voltage protection transmission unit, and is indicated by 704P. The voltage protection transceiver 700 may effectively mitigate the impact of signals with excessively high voltage level or with excessively low negative voltage level (an absolute voltage value is too high) on the electronic components of the output stage.

In the embodiment, the N-type voltage protection transmission unit 702N includes a transmission element 710 and a voltage-driven switch circuit 720. The transmission element 710 includes an impedance element 712 and a transmission circuit 714. An input terminal (N1) of the transmission element 710 is connected to the transmission terminal (Tx), and an output terminal (N2) thereof is connected to the receiving terminal (Rx). In an embodiment, a capacitor 102 can be disposed between the transmission element 110 and the transmission terminal (Tx) to serve as a coupling device. A capacitor 104 can also be disposed between the transmission element 110 and the receiving terminal (Rx) to serve as a coupling device. The impedance element 712 can be a resistor, a MOSFET or any other any device having a resistance characteristic, and in the embodiment, the impedance element 712 adopts a resistor.

In an embodiment, one terminal of the voltage-driven switch circuit 720 is connected to the connection node N1 of the transmission element 710, another terminal thereof is connected to a connection node N2 of the transmission element 710, and the impedance element 712 is located between the input terminal (N1) and the output terminal (N2). When the voltage value of the input signal is in a lower state, i.e. when the voltage value of the input terminal (N1) is relatively low, the voltage-driven switch circuit 720 is in the turn-off state, and the voltage-driven switch circuit 720 is isolated from the input signal. In the embodiment, the situation that the voltage value of the input signal is in the lower state refers to that the signal to be transmitted by the transmission element 710 is within a voltage range of a general or normal state.

When the voltage value of the input signal is gradually increased to reach a constant value, i.e. the voltage value of the input terminal (N1) is relatively high, the voltage-driven switch circuit 720 is in the turn-on state, and now the protection switch 725 establishes a current path connected to the ground at the connection node N2 for coupling the output terminal (N2) to the ground, so that the receiving terminal (Rx) coupled to the voltage protection transceiver 700 is avoided to be impacted by a high voltage signal input through the voltage protection transceiver 700. In one of a plurality of embodiments, when the voltage-driven switch circuit 720 is in the turn-on state, a resistance is further provided in the current path established by the protection switch 725 to form a voltage dividing circuit with the transmission element 710, so that when the voltage value of the input signal exceeds a predetermined value, impact of the high voltage level input signal on the electronic components of the output terminal is effectively mitigated.

In one of a plurality of embodiments, the voltage-driven switch circuit 720 includes a decoupling element 723, a protection circuit 724 and a protection switch 725. The voltage-driven switch circuit 720 further includes a plurality of passive components for connecting the aforementioned protection circuit 724 to the transmission element 710. For example, in an embodiment, the decoupling element 123 can be a decoupling transistor. The protection circuit 724 may include a resistor 724b and a Zener diode 724a, or can be the aforementioned back-to-back gate protection diode set. The protection switch 725 may include field effective transistors 725a and 725b, where the field effective transistor 725a is used for constructing a current path for coupling the transmission element 712 to the ground, and the field effective transistor 725b serves as an impedance element by connecting a gate thereof with a drain/source terminal thereof.

The input terminal of the voltage-driven switch circuit 720 is coupled to the transmission element 710 via the decoupling element 723 through the passive components. As that shown in FIG. 7A, the passive components, for example, include a resistor 721 and a capacitor 722. One end of the resistor 721 is coupled to the input terminal (N1) of the transmission element 710. Another end of the resistor 721 is coupled to the connection node N3, and is coupled to an input terminal of the decoupling element 723, and is coupled to a control terminal of the decoupling element 723 and the protection circuit 724 through the capacitor 722 and the connection node N4. An output terminal of the decoupling element 723 is connected to the protection switch 725 for controlling an operation state of the protection switch 725, i.e. control the turn-on or turn-off state of the field effective transistor 725a. In an embodiment, the decoupling element 723 may adopts a MOSFET 123a, where a gate thereof is connected to the connection node N4, and drain/source terminals thereof are respectively connected to the connection node N3 and the connection node N5.

When the voltage-driven switch circuit 720 is in the turn-off state, i.e. the voltage value of the input signal is relatively small, the decoupling element 723 is in the turn-off state, and the voltage-driven switch circuit 720 is isolated from the transmission element 710, i.e. isolated from the input signal. When the voltage value of the input signal is gradually increased to reach a constant value, the decoupling element 723 is switched to the turn-on state, and finally clamps the protection circuit 724 to a certain voltage. Now, the protection switch 725 is turned on to couple the voltage of the output terminal (N2) of the transmission element 710 to the ground, so as to short the output terminal of the voltage protection transceiver 700 to the ground and protect the output terminal of the voltage protection transceiver 700 from being impacted by the high voltage level signal input from the input terminal of the voltage protection transceiver 700.

In the embodiment, the P-type voltage protection transmission unit 704P includes a transmission element 730 and a voltage-driven switch circuit 740. The transmission element 730 includes an impedance element 732 and a transmission circuit 734. An input terminal (N6) of the transmission element 730 is connected to the transmission terminal (Tx), and an output terminal (N7) thereof is connected to the receiving terminal (Rx). As that described above, a capacitor 102 can be disposed between the transmission element 710 and the transmission terminal (Tx) to serve as a coupling device. A capacitor 104 can also be disposed between the transmission element 710 and the receiving terminal (Rx) to serve as a coupling device. The impedance element 732 can be a resistor, a MOSFET or any other any device having a resistance characteristic, and in the embodiment, the impedance element 732 adopts a resistor. One terminal of the voltage-driven switch circuit 740 is connected to the input terminal (N6) of the transmission element 730, another terminal thereof is connected to an output terminal (N7) of the transmission element 730, and the transmission element 730 is located between the input terminal (N6) and the output terminal (N7). When the voltage value of the input signal has a negative value and an absolute value thereof is in a lower state, i.e. when the voltage value of the input terminal (N6) is lower than zero though the absolute voltage value is in a lower state, the voltage-driven switch circuit 740 is in the turn-off state, and the voltage-driven switch circuit 740 is isolated from the input signal.

When the voltage value of the input signal is gradually decreased and the absolute voltage value thereof reaches or exceeds a predetermined value, i.e. the voltage value of the input terminal (N6) has a negative value and is excessively low, the voltage-driven switch circuit 740 is in the turn-on state, and now the protection switch 745 establishes a current path connected to the ground at the output terminal (N7) for coupling the output terminal (N7) to the ground, so that the receiving terminal (Rx) coupled to the voltage protection transceiver 700 is avoided to be impacted by an excessively low voltage input through the voltage protection transceiver 700. In one of a plurality of embodiments, when the voltage-driven switch circuit 740 is in the turn-on state, a resistance is further provided in the current path established by the protection switch 745 to form a voltage dividing circuit with the transmission element 730, so that when the voltage value of the input signal exceeds a predetermined value, impact of the input signal on the electronic components of the output terminal is effectively mitigated. Here, the aforementioned predetermined value is an allowable voltage value predetermined to avoid impact of the input high voltage level signal.

In one of the embodiments, the voltage-driven switch circuit 740 includes a decoupling element 743, a protection circuit 744 and a protection switch 745. The voltage-driven switch circuit 420 further includes a plurality of passive components for connecting the aforementioned protection circuit to the transmission element 730. For example, in an embodiment, the decoupling element 743 can be a decoupling transistor, and in the embodiment, the decoupling element 743 is a PMOS. The protection circuit 744 may include a resistor 744a and a Zener diode 744b, or may adopt the aforementioned back-to-back gate protection diode set in other embodiments. The protection switch 745 may include field effective transistors 745a and 745b, where the field effective transistor 745a is used for constructing a current path for coupling the transmission element 730 to the ground, and the field effective transistor 745b serves as an impedance element by connecting a gate thereof with a drain/source terminal thereof. Certainly, resistors of the passive component can also be adopted. In the embodiment, the field effective transistor 745a is a PMOS.

The input terminal of the voltage-driven switch circuit 740 is coupled to the transmission element 730 via the decoupling element 743 through the passive components. As that shown in FIG. 7A, the passive components, for example, include a resistor 741 and a capacitor 742. One end of the resistor 741 is coupled to the input terminal (N6) of the transmission element 730. Another end of the resistor 741 is coupled to the connection node N8, and is coupled to an input terminal of the decoupling element 743, and is coupled to a control terminal of the decoupling element 743 and the protection circuit 744 through the capacitor 742 and the connection node N9. An output terminal of the decoupling element 743 is connected to the protection switch 745 for controlling an operation state of the protection switch 745, i.e. control the turn-on or turn-off state of the field effective transistor 745a. In an embodiment, the decoupling element 743 may adopts a PMOS, where a gate thereof is connected to the connection node N9, and drain/source terminals thereof are respectively connected to the connection node N8 and the connection node N10.

When the voltage-driven switch circuit 740 is in the turn-off state, i.e. the voltage value of the input signal is relatively small, the decoupling element 743 is in the turn-off state, and the voltage-driven switch circuit 740 is isolated from the transmission element 730, i.e. isolated from the input signal. When the voltage value of the input signal is gradually decreased and an absolute value thereof reaches or exceeds a constant value, the decoupling element 743 is switched to the turn-on state, and finally clamps the protection circuit 744 to a certain voltage. Now, the protection switch 745 is turned on to couple the voltage of the output terminal (N7) of the transmission element 730 to the ground, so as to short the output terminal of the voltage protection transceiver 700 to the ground and protect the output terminal of the voltage protection transceiver 700 from being impacted by the high voltage level signal input from the input terminal of the voltage protection transceiver 700.

Referring to FIG. 7B, FIG. 7B is a structural schematic diagram of a voltage protection transceiver according to an embodiment of the disclosure. The voltage protection transceiver 700 also includes the N-type voltage protection transmission unit 702N of the upper part and the P-type voltage protection transmission unit 704P of the lower part as that shown in FIG. 7A, and the same elements or structures adopt the same referential numbers, which are not repeated. A difference between FIG. 7B and FIG. 7A is that a protection circuit 726 is further added between the receiving terminal (Rx) and the connection node N2 for coupling to the voltage value of the transmission elements 710 and 730, such that the connection node N2 or N7 is clamped to a certain voltage. In one or a part of the exemplary embodiments, the protection circuit 726 includes a diode wheel.

Referring to FIG. 7C, FIG. 7C is a schematic diagram of a voltage protection transceiver according to an embodiment of the disclosure. In the embodiment, the voltage protection transceiver 700 also includes the N-type voltage protection transmission unit 702N of the upper part and the P-type voltage protection transmission unit 704P of the lower part as that shown in FIG. 7A, and the same elements or structures adopt the same referential numbers, which are not repeated. A difference between FIG. 7C and FIG. 7A is that the protection switch 725 may include a field effective transistor 725a to serve as a driving circuit and an impedance element, and the protection switch 745 may include a field effective transistor 745a to serve as a driving circuit and an impedance element. The field effective transistors 725a and 745a are respectively used for establishing a current path for coupling the transmission elements 710 and 730 to the ground, and the field effective transistors 725a and 745a may respectively use its own impedance value to serve as the impedance element. In the embodiment, the field effective transistor 745a is a PMOS.

In the voltage protection transceiver provided by one or a part of the embodiments of the disclosure, in order to efficiently maintain stableness of the transmission element, the parallel structure described in the embodiments of FIG. 7A-FIG. 7C can be used to quickly protect the transmission path from being damaged by excessively high or low voltage input of the voltage signal. In other embodiments, a plurality of the N-type voltage protection transmission units and/or the P-type voltage protection transmission units disclosed in the embodiments of FIG. 7A-FIG. 7C can be connected in series or in parallel or arranged in an array to effectively maintain stableness of the transmission element, so as to quickly protect the transmission path from being damaged by the high voltage level signal input. Such parallel structure is described below in different embodiments with reference of the structure of FIG. 1. The voltage protection transceiver 100 includes the transmission element 110 and the voltage-driven switch circuit 120. The voltage-driven switch circuit 120 at least includes the protection switch 101 and the switch circuit 103.

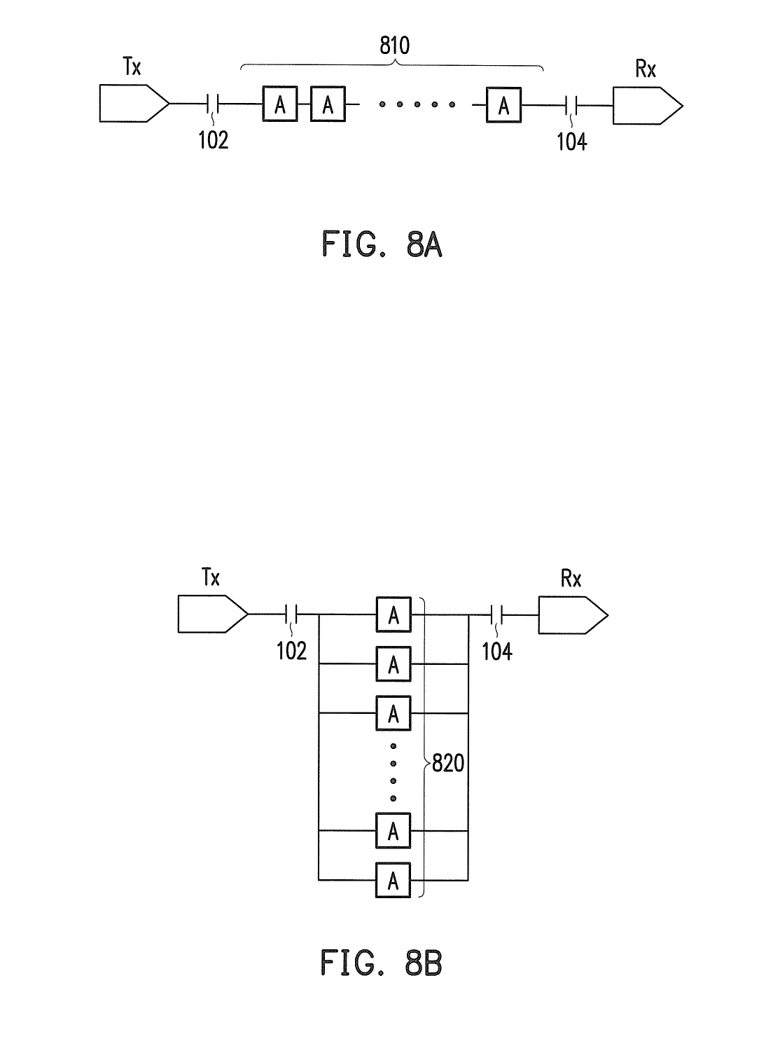

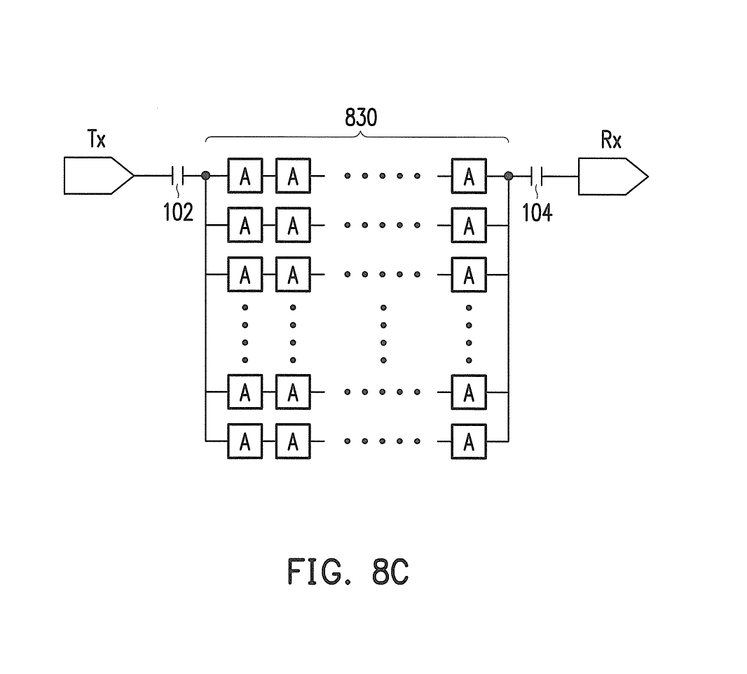

Referring to FIG. 8A, FIG. 8A is a structural schematic diagram of a voltage protection transceiver according to an embodiment of the disclosure. The voltage protection transceiver may include a serial voltage protection transmission unit 830, and the serial voltage protection transmission unit 830 is composed of a plurality of N-type voltage protection transmission units connected in series. The serial voltage protection transmission unit 830 is connected to the transmission terminal (Tx) through the capacitor 102, and is also connected to the receiving terminal (Rx) through the capacitor 104. The N-type voltage protection transmission unit of the serial voltage protection transmission unit 830 can be one or a part of that in the embodiments of FIGS. 2A-2B, FIG. 3-FIG. 6 and FIGS. 7A-7C or a combination thereof. In another embodiment, the serial voltage protection transmission unit 830 can include a plurality of P-type voltage protection transmission units connected in series that are described in FIGS. 7A-7C, or composed of the N-type voltage protection transmission units and the P-type voltage protection transmission units arranged in interleaving or connected in series in any sequence.

Referring to FIG. 8A, FIG. 8A is a schematic diagram of a voltage protection transceiver according to an embodiment of the disclosure. The voltage protection transceiver may include a serial voltage protection transmission unit 810, and the serial voltage protection transmission unit 810 is composed of a plurality of N-type voltage protection transmission units connected in series (“N” in FIG. 8A is denoted as the N-type voltage protection transmission unit). The serial voltage protection transmission unit 810 is connected to the transmission terminal (Tx) through the capacitor 102, and is connected to the receiving terminal (Rx) through the capacitor 104. The N-type voltage protection transmission unit of the serial voltage protection transmission unit 810 can be one or a part of that in the embodiments of FIGS. 2A-2B, FIG. 3-FIG. 6 and FIGS. 7A-7C or a combination thereof. In another embodiment, the serial voltage protection transmission unit 810 can be composed of a plurality of P-type voltage protection transmission units connected in series that are described in FIGS. 7A-7C, or composed of the N-type voltage protection transmission units and the P-type voltage protection transmission units arranged in interleaving or connected in series in any sequence.

Referring to FIG. 8B, FIG. 8B is a schematic diagram of a voltage protection transceiver according to an embodiment of the disclosure. The voltage protection transceiver may include a parallel voltage protection transmission unit 820, and the parallel voltage protection transmission unit 820 is composed of, for example, a plurality of N-type voltage protection transmission units connected in parallel (“N” in FIG. 8B is denoted as the N-type voltage protection transmission unit). Each voltage protection transmission unit of the parallel voltage protection transmission unit 820 is connected to the transmission terminal (Tx) through the capacitor 102, and is connected to the receiving terminal (Rx) through the capacitor 104. The N-type voltage protection transmission unit of the parallel voltage protection transmission unit 820 can be one or a part of that in the embodiments of FIGS. 2A-2B, FIG. 3-FIG. 6 and FIGS. 7A-7C or a combination thereof. In another embodiment, the parallel voltage protection transmission unit 820 can be composed of a plurality of P-type voltage protection transmission units connected in parallel that are described in FIGS. 7A-7C, or composed of the N-type voltage protection transmission units and the P-type voltage protection transmission units arranged in interleaving or connected in parallel in any sequence.

Referring to FIG. 8C, FIG. 8C is a schematic diagram of a voltage protection transceiver according to an embodiment of the disclosure. The voltage protection transceiver may include an array-type voltage protection transmission unit 830, and the array-type voltage protection transmission unit 830 is composed of a plurality of voltage protection transmission units arranged in an array such as a plurality of N-type voltage protection transmission units (“N” in FIG. 8C is denoted as the N-type voltage protection transmission unit). The array-type voltage protection transmission unit 830 is connected to the transmission terminal (Tx) through the capacitor 102, and is connected to the receiving terminal (Rx) through the capacitor 104. The N-type voltage protection transmission unit of the array-type voltage protection transmission unit 830 can be one or a part of that in the embodiments of FIGS. 2A-2B, FIG. 3-FIG. 6 and FIGS. 7A-7C or a combination thereof. In another embodiment, the array-type voltage protection transmission unit 830 can be composed of a plurality of P-type voltage protection transmission units arranged in a matrix that are described in FIGS. 7A-7C, or composed of the N-type voltage protection transmission units and the P-type voltage protection transmission units arranged in interleaving or arranged in any sequence.

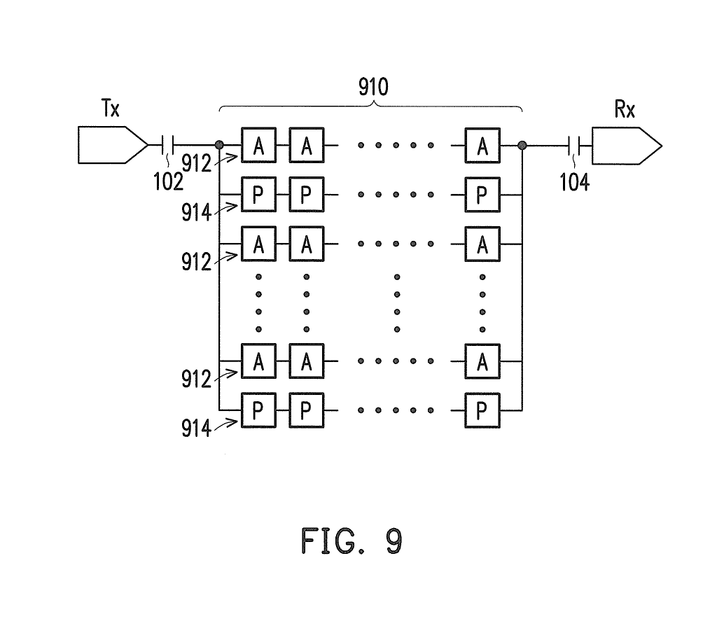

Referring to FIG. 9, FIG. 9 is a schematic diagram of a voltage protection transceiver according to an embodiment of the disclosure. The voltage protection transceiver may include an array-type voltage protection transmission unit 910, and the array-type voltage protection transmission unit 910 is composed of a plurality of voltage protection transmission units arranged in an array. The array-type voltage protection transmission unit 910 is composed of the N-type voltage protection transmission units (“N” in FIG. 9 is denoted as the N-type voltage protection transmission unit) and the P-type voltage protection transmission units (“P” in FIG. 9 is denoted as the P-type voltage protection transmission unit) arranged in interleaving or arranged in any sequence, and is connected to the transmission terminal (Tx) through the capacitor 102, and is connected to the receiving terminal (Rx) through the capacitor 104. The N-type voltage protection transmission unit of the array-type voltage protection transmission unit 910 can be one or a part of that in the embodiments of FIGS. 2A-2B, FIG. 3-FIG. 6 and FIGS. 7A-7C. The P-type voltage protection transmission units can be the P-type voltage protection transmission units described in FIGS. 7A-7C that are arranged in a matrix, or the array-type voltage protection transmission unit 910 can be composed of the N-type voltage protection transmission units and the P-type voltage protection transmission units arranged in interleaving or arranged in any sequence.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A voltage protection transceiver, comprising:
a transmission element, comprising a first terminal coupled to an input terminal for receiving an input signal, and a second terminal coupled to an output terminal; and
a voltage-driven switch circuit, connected to the transmission element, and detecting a voltage value at the first terminal of the transmission element, wherein when the voltage value at the first terminal is lower than a predetermined voltage value, the voltage-driven switch circuit is in a turn-off state, and when the voltage value at the first terminal is higher than the predetermined voltage value, the voltage-driven switch circuit is in a turn-on state and forms a first current path connected to ground, so as to electrically couple the output terminal, which is coupled to the second terminal of the transmission element, to the ground.

2. The voltage protection transceiver as claimed in claim 1, wherein the voltage-driven switch circuit at least comprises a protection switch and a switch circuit, wherein the protection switch is configured to detect a voltage value of an input signal at the first terminal of the transmission element, and accordingly controls a conducting state of the switch circuit, one terminal of the switch circuit is coupled to the second terminal of the transmission element, and another terminal of the switch circuit is coupled to the ground, when the switch circuit is turned on, the first current path is formed to electrically couple the output terminal, which is coupled to the second terminal of the transmission element, to the ground.

3. The voltage protection transceiver as claimed in claim 2, wherein the transmission element comprises an impedance element, and the switch circuit comprises a resistance, when the first current path is formed, the impedance element and the resistance form a voltage dividing circuit, wherein a resistance of the impedance element is greater than the resistance of the switch circuit.

4. The voltage protection transceiver as claimed in claim 2, wherein the voltage-driven switch circuit comprises a decoupling element having one terminal coupled to the first terminal of the transmission element and another terminal coupled to the switch circuit for controlling a conducting state of the switch circuit through a voltage value of the input signal at the first terminal of the transmission element, so as to control the conducting state of the switch circuit.

5. The voltage protection transceiver as claimed in claim 4, wherein the voltage-driven switch circuit further comprises a protection circuit disposed between the decoupling element and the switch circuit, and coupled to the voltage value of the input signal at the first terminal of the transmission element for clamping a node located between the decoupling element and the switch circuit to a certain voltage.

6. The voltage protection transceiver as claimed in claim 5, wherein the protection circuit comprises a limiter.

7. The voltage protection transceiver as claimed in claim 6, wherein the limiter is a diode wheel.

8. The voltage protection transceiver as claimed in claim 1, further comprising a limiter coupled to the transmission element for limiting a voltage value output by the voltage protection transceiver.

9. The voltage protection transceiver as claimed in claim 1, further comprising:
a second transmission element, having a third terminal coupled to the input terminal for receiving the input signal, and a fourth terminal coupled to the output terminal; and
a second voltage-driven switch circuit, connected to the second transmission element, and detecting a voltage value at the third terminal of the transmission element, wherein when the voltage value at the third terminal is lower than the predetermined voltage value, the second voltage-driven switch circuit is in the turn-off state, and when the voltage value at the third terminal is higher than the predetermined voltage value, the second voltage-driven switch circuit is in the turn-on state and forms a second current path connected to the ground, so as to electrically couple the output terminal, which is coupled to the fourth terminal of the transmission element, to the ground.

10. The voltage protection transceiver as claimed in claim 9,
wherein the voltage-driven switch circuit at least comprises a first protection switch and a first switch circuit, wherein the first protection switch is configured to detect a voltage value of the input signal at the first terminal of the transmission element, and accordingly controls a conducting state of the first switch circuit, one terminal of the first switch circuit is coupled to the second terminal of the transmission element, and another terminal of the first switch circuit is coupled to the ground, when the first switch circuit is turned on, the first current path is formed to electrically couple the output terminal, which is coupled to the second terminal of the transmission element, to the ground, and
wherein the second voltage-driven switch circuit at least comprises a second protection switch and a second switch circuit, wherein the second protection switch is configured to detect a voltage value of the input signal at the first terminal of the transmission element, and accordingly controls a conducting state of the second switch circuit, one terminal of the second switch circuit is coupled to the fourth terminal of the second transmission element, and another terminal of the second switch circuit is coupled to the ground, when the second switch circuit is turned on, the second current path is formed to electrically couple the output terminal, which is coupled to the fourth terminal of the transmission element, to the ground.

11. The voltage protection transceiver as claimed in claim 10,
wherein the transmission element comprises an first impedance element, and the first switch circuit having a first resistance, when the first current path is formed, the first impedance element and the first resistance form a first voltage dividing circuit, wherein a resistance of the impedance element is greater than the first resistance of the switch circuit,
wherein the second transmission element comprises a second impedance element, and the second switch circuit having a second resistance, when the second current path is formed, the second impedance element and the second resistance form a second voltage dividing circuit, wherein a resistance of the second impedance element is greater than the second resistance of the second switch circuit.

12. The voltage protection transceiver as claimed in claim 10,
wherein the voltage-driven switch circuit comprises a first decoupling element having one terminal coupled to the first terminal of the transmission element and another terminal coupled to the first switch circuit for controlling a conducting state of the first switch circuit through a voltage value of the input signal at the first terminal of the transmission element, so as to control the conducting state of the first switch circuit,
wherein the second voltage-driven switch circuit comprises a second decoupling element having one terminal coupled to the third terminal of the second transmission element and another terminal coupled to the second switch circuit for controlling a conducting state of the second switch circuit through a voltage value of the input signal at the third terminal of the second transmission element, so as to control the conducting state of the second switch circuit.

13. The voltage protection transceiver as claimed in claim 12,
wherein the first voltage-driven switch circuit further comprises a first protection circuit disposed between the first decoupling element and the first switch circuit, and coupled to the voltage value of the input signal at the first terminal of the transmission element for clamping a first node located between the first decoupling element and the first switch circuit to a first certain voltage,
wherein the second voltage-driven switch circuit further comprises a second protection circuit disposed between the second decoupling element and the second switch circuit, and coupled to the voltage value of the input signal at the third terminal of the second transmission element for clamping a second node located between the second decoupling element and the second switch circuit to a second certain voltage.

14. The voltage protection transceiver as claimed in claim 13, wherein the protection circuit comprises a back-to-back gate protection diode set.

15. A voltage protection device, comprising a plurality of voltage protection transceivers, wherein the voltage protection transceivers are connected in parallel and are coupled to an input signal for detecting a voltage value of the input signal, when the voltage value is lower than a predetermined voltage value, the voltage protection transceivers are in a turn-off state, and when the voltage value is higher than the predetermined voltage value, at least one of the voltage protection transceivers or at least a part of the voltage protection transceivers are in a turn-on state and form one or a plurality of current paths for coupling an output terminal of a transmission element to the ground, wherein
each of the voltage protection transceivers comprises:
a transmission element, having a first terminal coupled to an input terminal for receiving an input signal, and a second terminal coupled to an output terminal; and
a voltage-driven switch circuit, connected to the transmission element, and detecting a voltage value at the first terminal of the transmission element, wherein when the voltage value at the first terminal is lower than a predetermined voltage value, the voltage-driven switch circuit is in a turn-off state, and when the voltage value at the first terminal is higher than the predetermined voltage value, the voltage-driven switch circuit is in a turn-on state and forms a first current path connected to ground, so as to electrically couple the output terminal, which is coupled to the second terminal of the transmission element, to the ground.

16. The voltage protection device as claimed in claim 15, wherein the voltage-driven switch circuit at least comprises a protection switch and a switch circuit, wherein the protection switch is configured to detect a voltage value of the input signal at the first terminal of the transmission element, and accordingly controls a conducting state of the switch circuit, one terminal of the switch circuit is coupled to the second terminal of the transmission element, and another terminal of the switch circuit is coupled to the ground, when the switch circuit is turned on, the current path is formed to electrically couple the output terminal, which is coupled to the second terminal of the transmission element, to the ground.

17. A voltage protection device, comprising a plurality of voltage protection transceivers, wherein the voltage protection transceivers are electrically connected in series, wherein a first voltage protection transceiver of the voltage protection transceivers connected in series is coupled to an input signal for detecting a voltage value of the input signal, when the voltage value is lower than a predetermined voltage value, the voltage protection transceivers are in a turn-off state, and when the voltage value is higher than the predetermined voltage value, the voltage protection transceivers are in a turn-on state and form one or a plurality of current paths for coupling an output terminal coupled to the voltage protection transceivers in the turn-on state to the ground.

18. The voltage protection device as claimed in claim 17, wherein each of the voltage protection transceivers comprises:
the transmission element, having a first terminal coupled to an input terminal for receiving an input signal, and a second terminal coupled to an output terminal; and
a voltage-driven switch circuit, connected to the transmission element, and detecting a voltage value at the first terminal of the transmission element, wherein when the voltage value at the first terminal is lower than a predetermined voltage value, the voltage-driven switch circuit is in a turn-off state, and when the voltage value at the first terminal is higher than the predetermined voltage value, the voltage-driven switch circuit is in a turn-on state and forms a first current path connected to ground, so as to electrically couple the output terminal, which is coupled to the second terminal of the transmission element, to the ground

19. A voltage protection device, comprising a plurality of voltage protection transceivers, wherein the voltage protection transceivers are arranged in an array, wherein
the voltage protection transceivers in a same row are coupled to an input signal in parallel,
the voltage protection transceivers in a same column are electrically coupled in series, wherein a first voltage protection transceiver of the voltage protection transceivers connected in series is coupled to the input signal,
the voltage protection transceivers are configured to detect a voltage value of the input signal, when the voltage value is lower than a predetermined voltage value, the voltage protection transceivers are in a turn-off state, and when the voltage value is higher than the predetermined voltage value, at least one voltage protection transceiver or at least a part of voltage protection transceivers are in a turn-on state and form one or a plurality of current paths for coupling an output terminal coupled to the at least one voltage protection transceiver or at least the part of voltage protection transceivers in the turn-on state to the ground.

20. The voltage protection device as claimed in claim 19, wherein each of the voltage protection transceivers comprises:
the transmission element, having a first terminal coupled to an input terminal for receiving an input signal, and a second terminal coupled to an output terminal; and
a voltage-driven switch circuit, connected to the transmission element, and detecting a voltage value at the first terminal of the transmission element, wherein when the voltage value at the first terminal is lower than a predetermined voltage value, the voltage-driven switch circuit is in a turn-off state, and when the voltage value at the first terminal is higher than the predetermined voltage value, the voltage-driven switch circuit is in a turn-on state and forms a first current path connected to ground, so as to electrically couple the output terminal, which is coupled to the second terminal of the transmission element, to the ground
